(19) United States
(12) Patent Application Publication
(10) Pub. No.: US 2009/0287701 A1
(43) Pub. Date: Nov. 19, 2009

(54) System and Method for Receiving and Displaying User Inputted Travel-Related Messages

(75) Inventors: Douglas John Breaker, Wilmette, IL (US); Thomas James Russell, Glen Ellyn, IL (US)

Correspondence Address: WILDMAN HARROLD ALLEN & DIXON LLP, 225 WEST WACKER DRIVE, SUITE 2800, CHICAGO, IL, 60606, US

(73) Assignee: ORBITZ WORLDWIDE, L.L.C., Chicago, IL (US)

(21) Appl. No.: 12/120,415

(22) Filed: May 14, 2008

(51) Int. Cl. G06F 17/30; G06F 3/048; G06F 7/06; G06F 15/16

(52) U.S. Cl. 707/7; 707/10; 715/733; 709/205; 715/747; 709/203; 707/E17.032; 707/E17.121

(57) ABSTRACT

A computer-implemented system and method that provides travel-related information to communication devices through a communication network. Travel-related messages are transmitted by users such as travelers at communication devices and are received at a travel update system. The travel-related messages received are stored for display by various selected travel-related categories. The travel-related messages are posted for display such that the messages are accessible to travelers operating the communication devices. The travel update system may be web-based with the travel-related messages displayed by travel category on a website. The travel-related messages may be inputted and accessed in near real time by various computer-based communication devices.

### FIELD OF THE INVENTION

The present invention relates to systems and methods for receiving travel-related messages and displaying such messages on communication devices, and in particular, to systems and methods that allow users to input and access travel-related messages from communication devices.

### BACKGROUND OF THE INVENTION

Many people reserve, book and purchase their travel arrangements over the Internet using a travel website. Travelers, for example, may use a personal computer to access one or more of the travel websites, which often provide information on weather conditions, airport facilities and services, restaurants, vendors, and entertainment options in the departure and destination cities for the traveler. A traveler may use this information to determine the amount of time needed to travel to and from the airport. However, travelers may find that the conditions affecting their travel plans all change very rapidly. Factors such as weather, traffic delays, airport parking, check-in line length, security wait times, flight delays, and taxi availability and wait times all contribute to the amount of time a traveler needs to get to and from the airport. However, if any of these conditions change or another delay occurs while the passenger is en route to the airport, the passengers may find out about the delay during their route or once they arrive at the airport.

Systems such as those described in U.S. Patent Application Publication No. 2004/0019606A1 gather and analyze travel-related data, such as data related to air travel, in order to make various predictions, such as predictions on travel delays. Travel predictions made involving airline flights, for example, may be cross-referenced with ticketed passengers who are likely to be affected by those delays. A message may be generated and sent by the system to passengers determined to possibly be affected by the travel delay. The messages may be in various forms (such as e-mail, telephone, text message, facsimile, etc.) and sent to particular communication devices pre-designated by the passengers. In such known notification systems, however, a traveler must wait for the system to send or transmit a message to their pre-designated communication device. Therefore, there is a need for a system and method that allows travelers to proactively submit and access travel-related messages while they are traveling.

### BRIEF DESCRIPTION OF THE DRAWINGS

FIG. 1 is a system diagram illustrating a communication network with an exemplary travel update system in communication with communication devices.

FIG. 2 is an example of a travel messages home page of a website.

FIG. 3 is an example of a quick view webpage of the website displaying various travel information related to a selected airport.

FIG. 4 is an example of a messages webpage of the website.

FIG. 5 is an example of a traffic webpage of the website.

FIG. 6 is an example of an airport security line webpage of the website.

FIG. 7 is an example of an airport travel tips webpage of the website.

FIG. 8 is an example of a travel update message input webpage of the website.

FIG. 9 is an example of a travel tip message input webpage of the website.

FIG. 10 is another example of a message input webpage of the website.

FIG. 11 is a process flow diagram illustrating a process for travel-related message processing.

FIG. 12 is a process flow diagram illustrating a spam processing process.

FIG. 13 is a process flow diagram illustrating a process for determining helpfulness ratings.

FIG. 14 is a process flow diagram illustrating a Short Message Service (SMS) interface exchange process.

FIG. 15 illustrates an example display at an SMS-based device of a communication exchange for input of a travel-related message.

### DETAILED DESCRIPTION

A travel update system is provided that allows travelers to input travel-related messages in real-time. The travel update system is also adapted to allow travelers to access the system and obtain current travel-related messages at the time that this information is most useful to them. Travelers may input travel-related messages to the travel update system through a variety of computer-implemented communication devices such as personal computers, laptop computers, mobile phones, smart phones, handheld computing devices, Personal Digital Assistants (PDAs), Short Message Service (SMS)-enabled devices, and Instant Messaging (IM)-enabled devices. The travel update system may, for example, receive, store and post travel-related messages regarding travel matters at specific airports. Additionally, the travel update system may display the travel-related messages received from travelers into time-sensitive and non-time sensitive categories. Time-sensitive messages may include travel update messages such as message updates regarding airport status, flight delays, traffic conditions, parking, weather conditions, security line wait times, taxi availability and wait times, etc. Non-time-sensitive messages may include general traveler tips, for example, that inform travelers on where to eat, shop, work, etc., such as at a particular airport. For purposes of this application, the term traveler is intended to mean any user of the travel update system, whether such person is actually traveling or not. As used herein, traveler and user are interchangeable terms.

The travel update system is advantageous to travelers by permitting users to pro-actively find out the status of various travel conditions at any moment during the course of their travel. For instance, the travel update system allows travelers to post travel-related messages that would minimize inconveniences related to other travelers' plans. The travel update system further allows travel-related messages posted by various users to be displayed and accessed by other users. Travelers communicating with the system have the opportunity to access these messages to more efficiently manage their wait time, both at the airport and en route to the airport. Travelers are also able to rate the helpfulness of messages submitted by others. These ratings are processed and may be used to determine the credibility of information submitted by another user, and minimize travelers' use of adverse or unnecessary information.

In one embodiment, a computer-implemented travel update system provides travel-related information to various communication devices through the communication network. An application server in communication with the communication devices receives travel-related messages from the communication devices for display by travel-related categories. A database stores the received travel-related messages that may be displayed by selected travel-related categories. The application server posts the travel-related messages such that the travel-related messages are accessible by travelers operating the communication devices. In one example, the application server communicates with the communication devices through a webserver that is configured to provide web pages of a website for display of the travel-related messages. The travel-related messages received at the application server are displayed in near real time (e.g. less than one second) for access by the communication devices communicating with the website.

The individual travel-related messages, for example, may be stored by airport at the travel update database. The application server is also configured to display the travel-related messages into time-sensitive and non-time sensitive categories. For instance, time-sensitive travel-related messages may be displayed by airport security time, airport traffic and flight status categories. The non-time-sensitive messages, for example, may be displayed as airport travel tips. A short message services (SMS) interface coupled for communication with the application server may be employed in the travel update system such that the SMS interface sends and receives travel-related messages in the form of text messages to and from SMS-enabled mobile communication devices. An instant messaging (IM) interface coupled for communication with the application server may also be employed in the travel update system to establish IM communication with IM-enabled communication devices.

The website webserver displays various webpages on its associated website. A message webpage may be provided that displays and identifies by category travel-related messages that were received within a predetermined time period from the communication devices. The application server of the travel update system may filter the travel-related messages to be displayed by travel-related category on the messages webpage in response to a traveler selecting a particular travel-related category at the messages webpage. A traffic webpage may be provided for displaying the travel-related messages received at the travel update system from the communication devices identified as relating to traffic information. An airport security line webpage may also be provided that displays travel-related messages received from the communication devices identified as relating to airport security information. Airport security statistical information received from an external data source is also displayed on the airport security line webpage. Examples of message input webpages are also provided. As seen, the message input webpages are configured to receive text-based travel-related messages associated with a particular airport, to receive selections of a travel category for association with the travel-related message, and to submit the travel-related message and travel category selection to the application server.

A method of providing travel-related information to communication devices through a communication network is also provided. Travel-related messages are received from travelers operating communication devices and the received travel-related messages are stored for display by various travel-related categories. The travel-related messages are posted such that the messages are accessible by travelers operating the communication devices. The travel-related messages received and stored at a travel update database may be segregated by airport. The received travel-related messages may, for example, be displayed on a website for near real time access (e.g. less than one second) by communication devices interacting with the website.

The travel update system is adapted to receive and respond to text-based travel-related messages from short message services (SMS)-enabled mobile communication devices as well as establishing instant messaging (IM) communication with IM-enabled communication devices. The travel-related messages received from travelers operating communication devices may be aggregated with travel-related data received from external data sources with the travel-related messages and the travel related data stored in the travel update database. As provided herein, the travel update system may provide helpfulness ratings by calculating a percentage of votes received for individual ones of the travel-related messages that indicate the travel-related message was helpful and displaying the travel-related messages in order from highest percentage to lowest percentage of helpfulness votes. Statistics on individual travelers based on message ratings associated with the travel-related messages submitted by the individual travelers may be stored in the travel update database. The travel update system also filters out spam messages from the travel-related messages received.

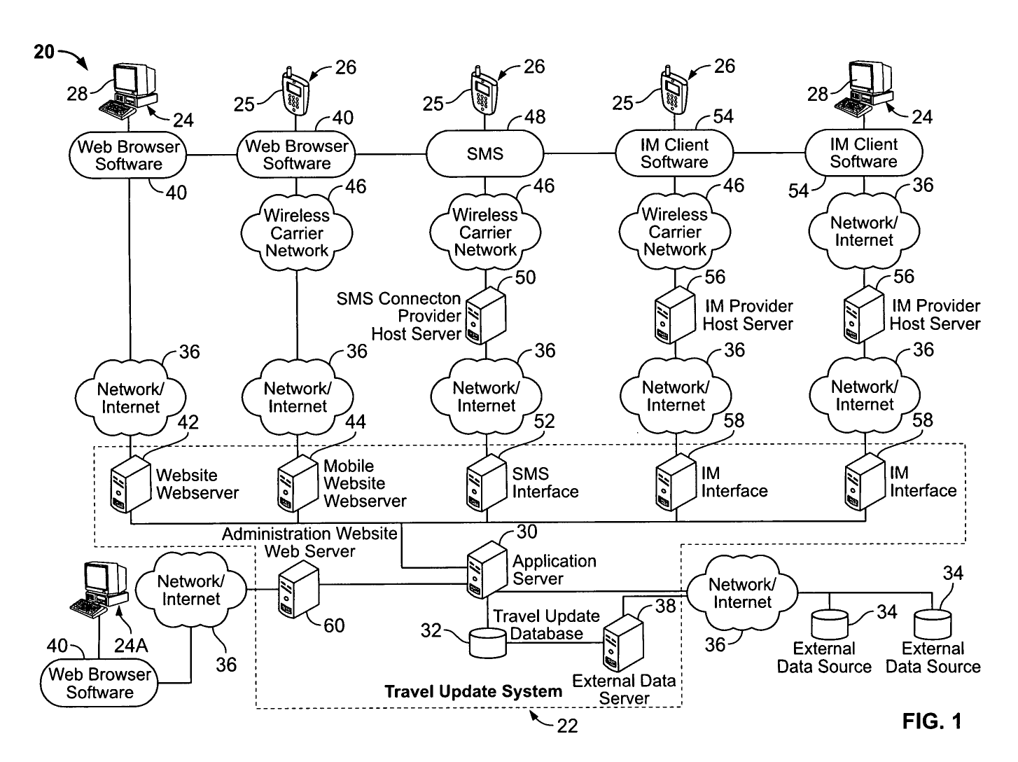

Referring to FIG. 1, communication network 20 is shown with travel update system 22 configured to receive and communicate travel-related messages to various communication devices 24, 26 that may be operated by a traveler. The communication devices, for example, may include personal computing devices 24 (such as desktop or laptop computers) and mobile communication devices 26. The communication devices may be any type of device that is capable of connecting to a network, displaying information received through the network, and receiving information to be transmitted through the network. Display devices 28 are provided at the respective communication devices to 24, 26 enable the user to view messages input from and received at communication devices 24, 26. Travelers at respective communication devices 24, 26 may generate and send travel-related update messages, which are transmitted through communication network 20 to travel update system 22. The messages are received and processed at application server 30 of travel update system 22 and stored at travel update database 32 for the benefit of other users, such as other airport travelers. Thus, travelers may also receive travel-related messages by accessing travel update system 22. Travel update database 32 of travel update system 22 may also receive data from external data sources 34 that transmit data through a computer network 36 such as the Internet to application server 30. Certain data received from external data sources 34 may be filtered by application server 30 (or alternatively by external data server 38) and is sent to travel update database 32. Other data obtained from external data sources 34 may be displayed directly on the website by application server 30. Data received the from the external data sources may include, for example, data from the Federal Aviation Administration (“FAA”) website, data from the Transportation Safety Administration (“TSA”), or other travel-related data.

As seen in FIG. 1, travel update system 22 is configured to provide website communication with communication devices, such as personal computing device 24. In this example, web browser software 40 resides on personal computer 24 for communication with website webserver 42 over a computer network 36 such as the Internet. For example, web browser software may be used to send information to and receive and display web pages from website webserver 42 over computer network 36. A traveler may generate and submit a travel-related message using personal computing device 24. The message data is transmitted from the web browser software 40 residing on personal computing device 24 over the network 36 to website webserver 42. The website webserver 42 sends the message data to application server 30, which saves the data in travel update database 32. Application server 30 also processes the received data and formats the information pulled from the travel update database 30 for display on one or more web pages of the website associated with website webserver 42.

Travel update system 22 is also configured to communicate with mobile communication devices 26 such as mobile telephones, smart phones or personal digital assistants. Web browser software 40 resides on mobile communication device 26 for communication with mobile website webserver 44. Web browser software 40 on mobile communication device 26 may be used to send information to and receive and display web pages from mobile website webserver 44. A user may generate and submit a travel-related message using mobile communication device 26. Mobile communication device 26 transmits message data to supporting wireless carrier network 46, through computer network 36 (such as the Internet) and to mobile website webserver 44. Mobile communication device 26 running web browser software 40 also receives web pages from mobile website webserver 44 through computer network 36 and wireless carrier network 46. Mobile website webserver 44 transmits the data to application server 30, which analyzes and filters the data and saves it to travel update database 32. The information is then formatted and made available for display on a web page on the website.

Referring still to FIG. 1, travel update system 22 is also configured to provide Short Message Service (SMS) communication with mobile communication devices 26 having SMS capabilities. A traveler, for instance, may generate and submit a SMS or text message using an SMS-enabled mobile communication device 26 having SMS function software 48. Mobile communication device 26 transmits data through a supporting wireless carrier network 46. The wireless carrier network 46 transmits the data to SMS connection provider host server 50 and through a public or private computer network 36, such as the Internet. SMS interface 52 receives the data from computer network 36 and sends the data to application server 30 where the information is analyzed and filtered. Application server 30 saves the data at travel update database 32 where the information is formatted and made available for display on one or more web pages of the website. SMS interface 52 allows travelers to transmit updates and receive travel information via SMS and receive real-time travel information about an airport, including traffic, weather, FAA information, TSA information and other travel updates and tips.

Travel update system 22 may also be configured to provide instant messaging (IM) communication with mobile communication devices 26. In this example, IM client software 54 resides and runs on IM-enabled mobile communication device 26. A traveler may generate and submit an IM update providing travel-related messages using mobile communication device 26. Mobile communication device 26 transmits the data from its IM client software 54 to supporting wireless carrier network 46. The wireless carrier network 46 then sends the data to IM provider host server 56. IM provider host server 56 then transmits the data through computer network 36 such as the Internet to IM interface 58 of the travel update system 22. IM interface 58 then transmits the data to application server 30 where the information is analyzed and filtered. IM services allows travelers to transmit updates and receive near real-time travel information about an airport and other travel updates and tips via IM interface 58. The information is sent to and saved at travel update database 32, where it is made available for display on one or more web pages of the website.

Still referring to FIG. 1, as seen, travel update system 22 may also be configured to provide IM communication with personal computing devices 24. IM client software 54, in this example, resides and runs on personal computing device 24. A traveler, for instance, may generate and submit an IM update providing travel-related messages using personal computing device 24. The IM client software 54 operating at the IM-enabled personal computing device 24, sends the message data over a public or private network 36 such as the Internet to IM provider host server 56. IM provider host server 56 sends the travel-related messages through network 36 to IM interface 58. IM interface 58 sends the travel-related messages submitted by travelers to application server 30. Application server 30 analyzes and filters the received message data and saves the data to travel update database 32 where it is made available for display on the website. As understood by those skilled in the art, the various system interfaces (website webserver 42, mobile website webserver 44, SMS interface 52, IM interface 58) may physically reside on a single server device or alternatively on multiple server devices.

Administration of the travel update system 22 may be performed through interaction with a system administration website provided by administration website webserver 60. A system administrator may be stationed at a communication device such as personal computing device terminal 24A, which uses web browser software 40 to communicate with administration website webserver 60 over network 36 for interaction with the system administration website. The system administrator uses personal computing device 24A, for example, to analyze and monitor travel-related updates as well as monitor user identification information and system usage. The information received from the system administrator is sent to and processed at application server 30 and stored at travel update database 32.

External data sources 34 such as data sources associated with weather websites, air traffic websites (e.g. Federal Aviation Administration website), and the Transportation Safety Administration are data sources that may be accessed to determine or make predictions about present and future travel conditions. External data sources 34 may be accessed by travel update system 22 over computer network 36 such as the Internet. Application server 30 may, for example, obtain external data by accessing it in real time from an external data source (such as an external web service), process the data in the application layer, and display the external data accessed on the website. In another example, application server 30 may execute a routine at periodic times to obtain data from an external file server posted on the Internet. Travel Safety Administration (TSA) data, for instance, may be accessed from an external data source 34. In this example, application server 30 processes the accessed data and enters it into the travel update database 32. Application server 30 may interact with external data server 34 through computer network 36. An external data server 38 may alternatively be provided for use in accessing or processing data from external data sources 34. The external data information is received at application server 30 for processing and storage at travel update database 32 for website display.

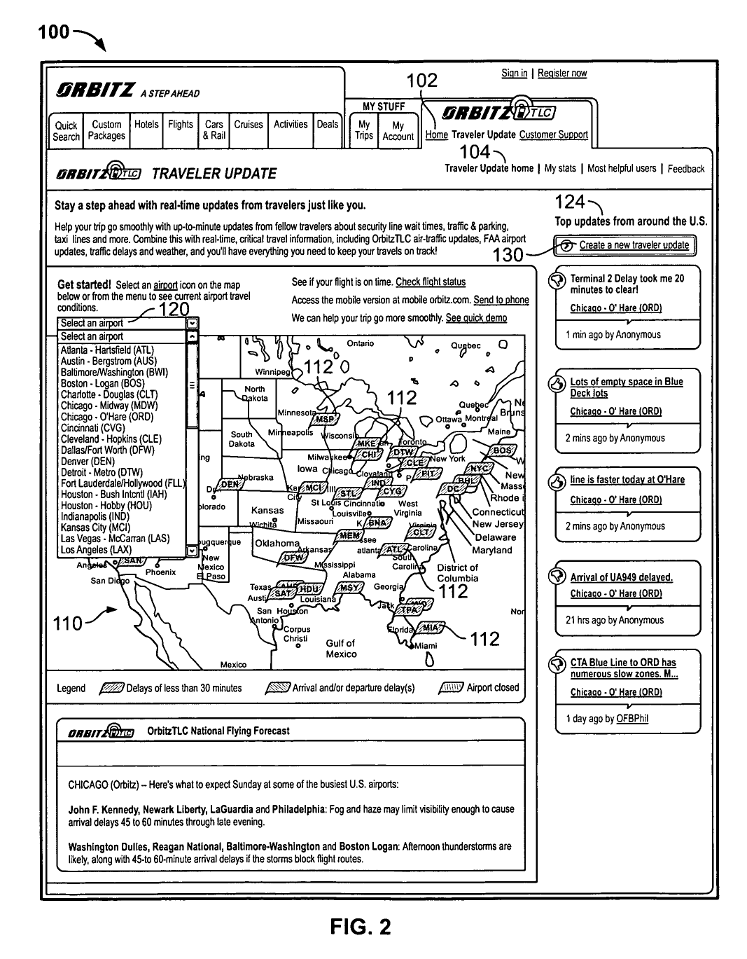

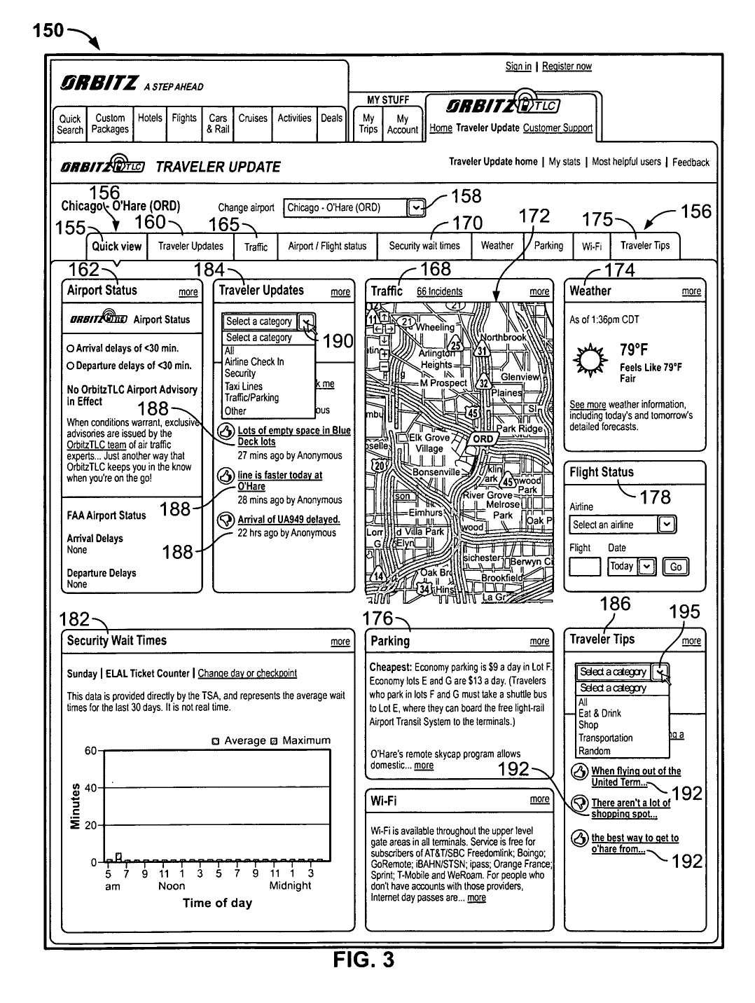

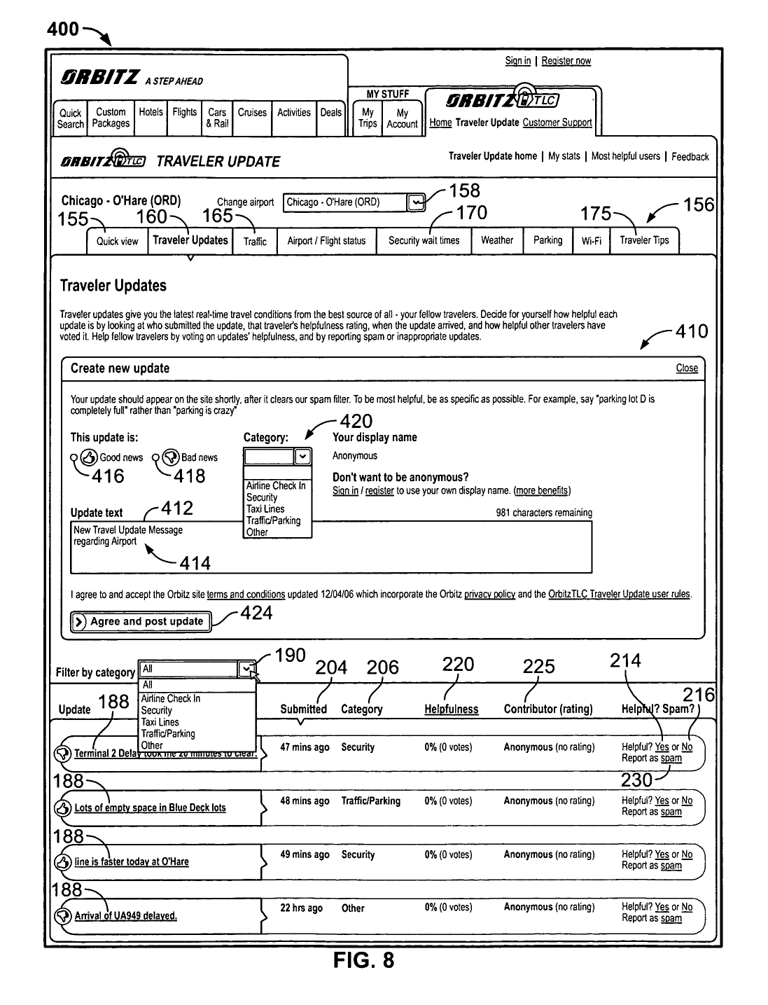

Referring to FIG. 2, an example of a travel messages home page 100 of traveler update website provided by website webserver 42 in conjunction with application server 30 is shown. Home page 100 may be accessed by actuation of home page links 102, 104 displayed at various pages of the website. In this example, home page 100 displays a geographic map 110 such as a map of the United States or any other geographic region, with various airport icons 112 (associated with corresponding airports or sub-locations) displayed on the map 110. A drop down menu 120 is also provided for selection of a particular airport. User selection of an airport icon 112 or an airport listed from drop down menu 120 moves the user to a quick view webpage (FIG. 3) that displays various travel information related to the airport selected. Home page 110 also displays a listing 124 of top travel-related messages associated with airports identified in the mapped geographic region, such as the United States. Link 130 to create a new travel-related update message is also provided on homepage 110. Actuation of link 130 will bring the user to travel update message input webpage 400 as seen in FIG. 8 to enable the user to create a new travel-related message associated with the selected airport.

Referring to FIG. 3, an example of a quick view webpage 150 of the traveler update website is shown displaying various travel information related to a selected airport. In this example, O'Hare airport in Chicago, Ill. has been selected. The quick view webpage 150 may also be presented by actuation of a quick view tab 155 that may be provided at various webpages associated with the particular selected airport. A quick view webpage associated with a different airport may be accessed for display by changing the selected airport through use of drop down menu 158. As seen, quick view webpage 150 provides an overview of different categories of information associated with the airport selected. In this example, quick view webpage 150 has airport status section 162 that provides status information about the airport (such as arrival or departure delays) or airport advisory information. Traffic section 168 displays a map 172 of the region near the airport and provides traffic information on various roads in the surrounding area. A weather section 174 displays weather information at or near the airport and parking section 176 provides airport parking information. Flight status section 178 allows a user to input information on an airline flight to obtain status information on the particular flight. Airport security line section 182 provides security wait time statistics at selected checkpoints for certain days of the week.

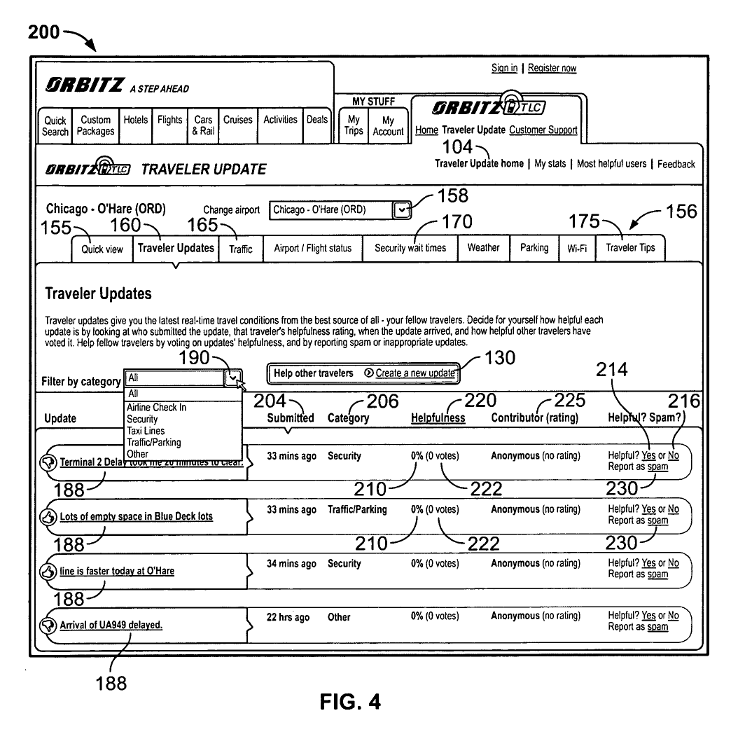

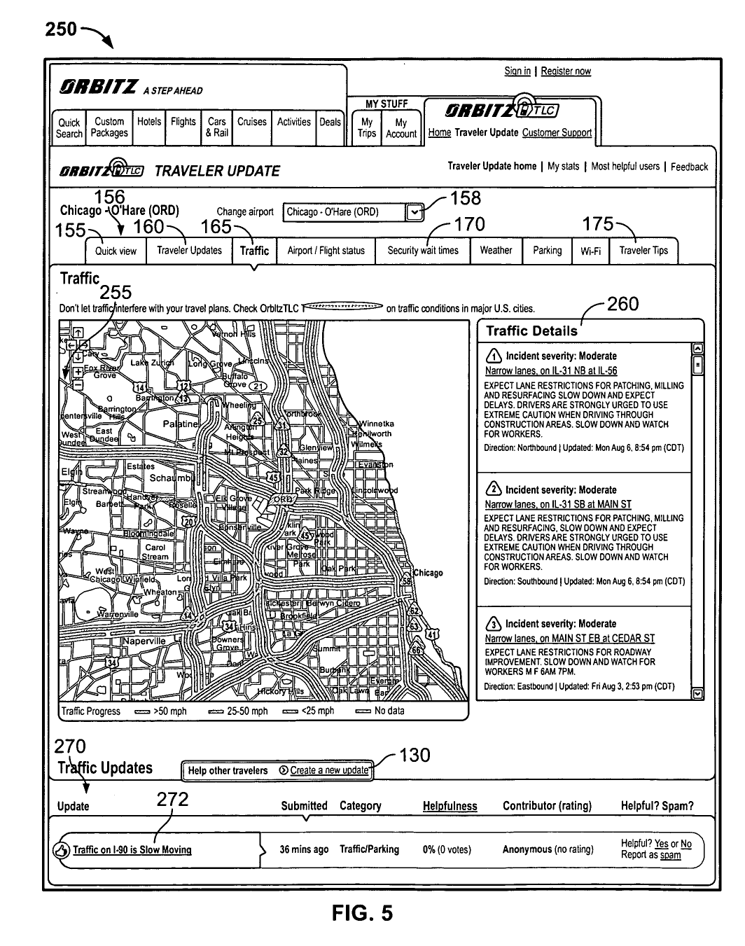

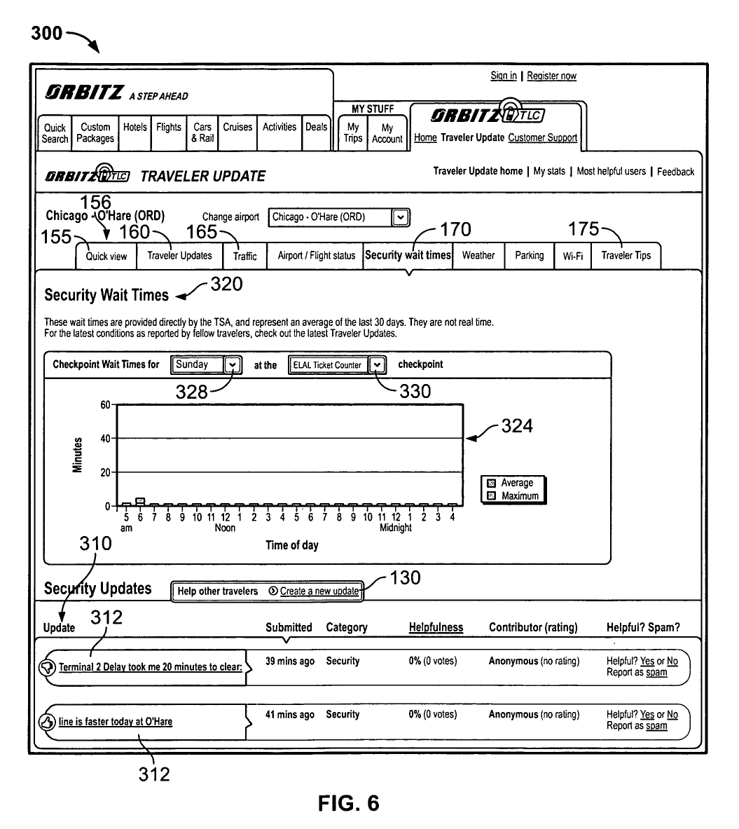

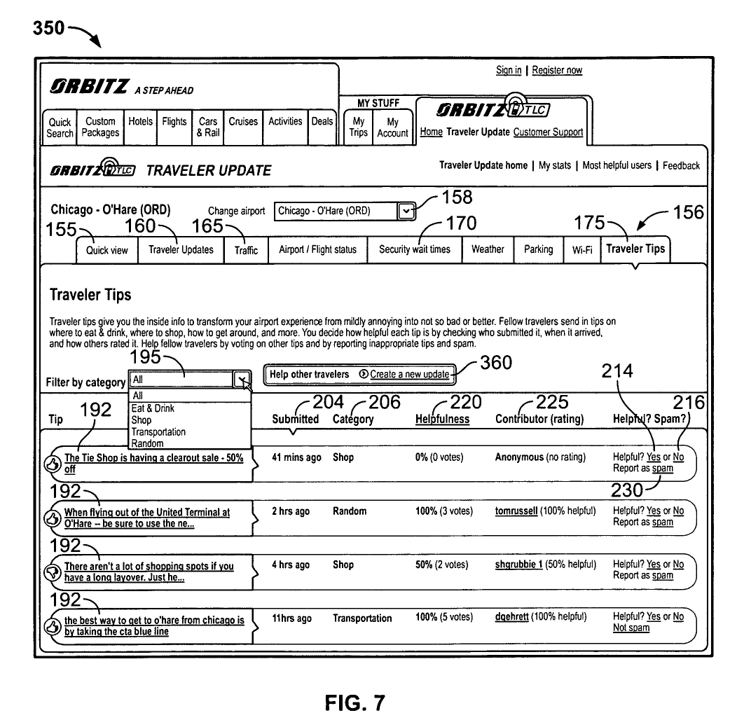

As seen in FIG. 3, quick view webpage 150 also displays airport traveler updates section 184 and airport traveler tips section 186. Traveler update database 32, FIG. 1, stores the received travel-related messages for display by time-sensitive and non-time sensitive categories. Traveler updates section 184 displays time-sensitive travel-related messages 188 and traveler tips section 186 displays non-time-sensitive messages 192 categorized by airport travel tips. The time-sensitive messages 188 received that are associated with the selected airport may be displayed by various categories such as airport traffic, airport security line, flight status, taxi line, or other time-sensitive categories by selection of a particular category from “select a category” drop down menu 190. Non-time sensitive airport travel tip messages 192 may also be displayed by selected categories (such as eat and drink, shop, transportation, etc.) through user selection of drop down menu 195 at the airport traveler tips section 186. Tab bar 156 is also provided with various tabs providing links to other webpages of the website. For example, traveler updates tab 160 provides a link to messages webpage 200 as seen in FIG. 4, traffic tab 165 provides a link to traffic webpage 250 as seen in FIG. 5, airport security tab 170 provides a link to airport security line webpage 300 as seen in FIG. 6, and travel tips tab 175 provides a link to airport travel tips webpage 350 as seen in FIG. 7.

Referring to FIG. 4, an example of a messages webpage 200 of the website is shown. Actuation of traveler updates tab 160 in tab bar 156 provides for the display of messages webpage 200. As seen in FIG. 4, the messages webpage 200 displays and identifies by category time-sensitive travel-related messages 188 received by the travel update system 22. The time-sensitive messages 188 displayed may be those that were received at travel update system 22, FIG. 1, within a predetermined period of time from users operating the communication devices 24, 26. For example, the travel-related messages 188, FIG. 4, displayed on messages webpage 200 may be time-sensitive messages received at system 22 within the past twenty-four (24) hours (or any other predetermined period of time). Messages webpage 200 may display all time-sensitive messages received within a predetermined time frame. Alternatively, application server 30 of travel update system 22 may filter the travel-related messages to be displayed by travel-related category on the messages webpage 200 in response to user selection of a particular travel-selected category from travel category drop down menu 190. For instance, a user may select a particular travel-related category (such as airline check in, airport traffic, airport security line categories, etc.) from drop down menu 190. In response to the travel category selection, application server 30 will filter down and display the time-sensitive travel-related message updates received within the predetermined period of time relating to the travel category selected by the user.

As seen in FIG. 4, information associated with each travel-related message 188 is also provided at messages webpage 200. Information relating to when the travel-related message 188 was submitted 204 is displayed. The particular travel-related category 206 identified by the user that posted the message is also provided. A helpfulness rating 210 associated with each message may also be displayed adjacent to the messages. Voting links 214, 216 are provided to allow users to vote whether an individual travel-related message was helpful or was not helpful. Application server 30, FIG. 1, then calculates the percentage of the votes received for the individual travel-related messages that indicate the travel-related message was helpful. The helpfulness rating percentage 210, FIG. 4, is displayed for each associated travel-related message 188. Actuation of helpfulness link 220 prompts application server 30 to display the travel-related messages in order from highest percentage to lowest percentage of helpfulness votes 222.

A contributor rating 225 is also displayed with the corresponding travel-related messages 188. Information identifying the traveler who submitted the message to the travel update system 22, FIG. 1, and a rating associated with that particular individual traveler is provided adjacent to the travel-related message displayed. Travel update database 32, FIG. 1, stores statistics on individual travelers based on message ratings associated with the travel-related messages submitted by the individual travelers. Based on the statistics stored for the individual travelers that submit messages to travel update system 22, a contributor rating 225, FIG. 4, is formed and displayed with the travel-related messages 188 provided by the submitting travelers. A spam link 230 is provided that allows a user to identify a displayed message as being a “spam” message. Such spam-identified messages may then be filtered out from the travel-related messages received by the application server 30.

Actuation of new message update link 130 will bring the user to travel update message input webpage 400 as seen in FIG. 8 to enable the user to create and input a new time-sensitive travel-related message. In this example, actuation of new message update link 130 will actually open and display the create new travel update section 410 on the messages webpage 200 to establish message input webpage 400 as seen in FIG. 8 providing the various prompts for the submission and posting of a new time-sensitive travel-related message.

Referring to FIG. 5, actuation of traffic tab 165 provides for the display of traffic webpage 250 associated with the selected airport. Traffic webpage 250 displays a map 255 of the geographic area proximate to the selected airport. In this example, the map 255 is color coded to provide the user with information on traffic conditions (such as the speed of travel) on various roads shown on the map. A traffic details section 260 provides details in text form relating to certain traffic incidents in the geographic region. Traffic webpage 250 has traffic updates section 270 displaying the travel-related messages 272 received from the communication devices 26, 28 identified as relating to traffic information. For example, a travel-related message regarding slow traffic on a particular road may be one type of message 272 identified as falling in the “traffic” category and may be displayed at traffic webpage 250. Travel-related messages that have been inputted by travelers submitting message updates as being in the “traffic” category are stored at travel update database 32, FIG. 1, for display at traffic webpage 250, FIG. 5.

Referring to FIG. 6, actuation of airport security tab 170 provides for the display of airport security line webpage 300 associated with the selected airport. Security updates section 310 of airport security line webpage 300 displays travel-related messages 312 received from communication devices 24, 26 identified by the user submitting the message as relating to airport security information. For example, travel-related messages 312 regarding delays or wait times at security lines or airport terminals may be displayed at security updates section 310. Airport security line webpage 300, as seen in FIG. 6, also has security wait times section 320 that displays airport security statistical information 324 received from an external data source. In this example, statistics on average check point wait times received from the Transportation Safety Administration (“TSA”) may be displayed in the security wait times section 320. Alternatively, any other airport security information including information received from different external data sources (such as Federal Aviation Administration “FAA” data sources) may be selectively be displayed. Interaction with drop down menus 328 will display wait time statistics for a different day of the week upon selection of a particular day from the drop down menu 328. Wait time information for different checkpoints may also be displayed in response to user selection of a different checkpoint through checkpoint drop down menus 330.

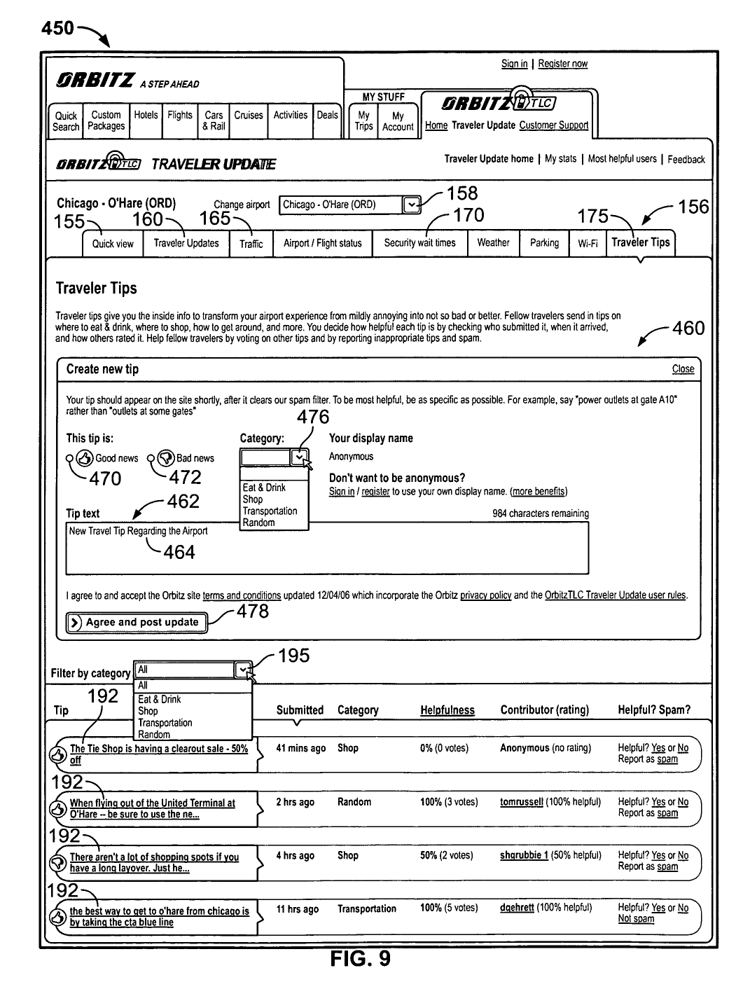

Referring to FIG. 7, an example of an airport travel tips webpage 350 is shown. Actuation of traveler tips tab 175 in tab bar 156 provides for the display of airport travel tips webpage 350. Airport travel tips webpage 350 is similar to messages webpage 200 described with reference to FIG. 4 except the airport travel tips webpage 350, FIG. 7, displays non-time-sensitive messages as airport travel tips 192. The airport travel tip messages 192 provide information related to the airport selected but is not necessarily time sensitive information. The travel tip messages 192 may be designated by a user as falling into one of a number of selectable categories associated with the particular airport. For example, the travel tip messages may be categorized by eating/drinking, shopping, transportation, or any other non-time-sensitive message category related to the airport. Actuation of new travel tip link 360 will bring the user to travel tip message input webpage 450 as seen in FIG. 9 to enable the user to create and input a new non-time-sensitive travel-related message. In this example, actuation of new travel tip link 360 will actually open a new travel tip section 460 on the airport travel tips webpage 350 to establish travel tip input webpage 450 as seen in FIG. 9 providing various prompts for the submission and posting of a new non-time-sensitive travel-related message as an airport travel tip.

Referring to FIG. 8, an example of a travel update message input webpage 400 of the website is shown. The travel update message input webpage 400 enables a traveler to input a text-based travel-related message associated with the selected airport. The traveler creating and inputting a new travel-related message selects a travel category associated with the travel-related message. In this example, travel update message input webpage 400, FIG. 8, is an extension of the messages webpage 200, FIG. 4, and displays a create new update section 410 in response to user actuation of new message update link 130 (FIG. 4). Alternatively, travel update messages input webpage 400 may be displayed as a separate webpage or provide a section for the input and submission of new travel-related messages as part of any other webpage of the website. Travel update message input webpage 400, FIG. 8, allows users to insert and submit new time-sensitive travel-related messages. Create new update section 410, in this example, includes message update text box 412 for the user to input a new text-based travel-related message 414. Prompts 416, 418 are provided allowing a user to indicate whether the time-sensitive travel-related message is good news or bad news. Category drop down menu 420 lists various time-sensitive travel categories that the user selects for association with the travel-related message. For instance, the user submitting a new message may select from travel categories such as: airline check in, airport security, airport traffic, taxi times, or other time-sensitive airport travel categories. Once the travel-related message text 414 is inserted and a travel category is selected, message posting button 424 may be actuated in order to submit (to the travel update system 22) the inputted travel-related message 414 associated with the selected airport. The travel-related message submitted from a communication device is received at the travel update system 22, FIG. 1. The received travel-related message is stored at the travel update database 32 by the travel category selected from drop down menu 420. If the submitted travel-related message 414 clears the spam filtering process of the travel update system 22, the message may be displayed on the website.

Referring to FIG. 9, an example of a travel tip message input webpage 450 is shown. The travel tip message input webpage 450 is similar to the travel update message input webpage 400 as seen and described with reference to FIG. 8 except the travel tip message input webpage 450 provides for the input and submission of non-time-sensitive travel-related messages as traveler tips. In this example, travel tip message input webpage 450, FIG. 9, is an extension of the airport travel tips webpage 350, FIG. 7, and displays create new tip section 460 in response to user actuation of new travel tip message link 360, FIG. 7. Alternatively, travel tip message input webpage 450 may be provided as a separate webpage or provide a section for the input and submission of new travel tip messages as part of any webpage on the website. Travel tip message input webpage 450 allows users to insert and submit new non-time-sensitive travel-related messages as travel tips. Create new tip section 460, in this example, includes travel tip text box 462 for the user to input a new text-based travel tip message 464. Prompts 470, 472 allow the user to indicate whether the travel tip is good news or bad news. Category drop down menu 476 lists various non-time-sensitive travel categories (such as eat/drink, shop, transportation, etc.) relating to the particular airport that the user selects for association with the inserted travel tip message 464. Once the text-based travel tip message 464 is inserted and a category from drop down menu 476 is selected, message posting button 478 may be actuated in order to submit the inputted travel-related tip message associated with the particular airport. The non-time-sensitive travel tip message 464 submitted from a communication device is received at travel update system 22, FIG. 1, and is stored at travel update database 32 by the travel category selected from drop down menu 476. If the submitted non-time-sensitive travel-related message (as a travel tip) clears a spam filtering process, the message may be displayed on the website.

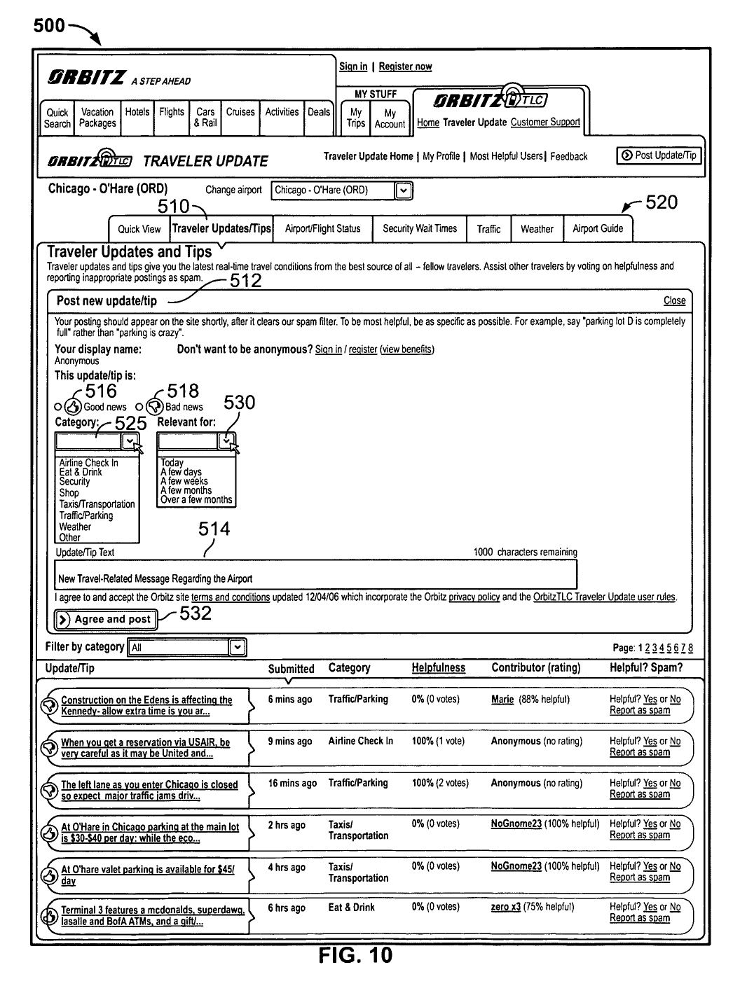

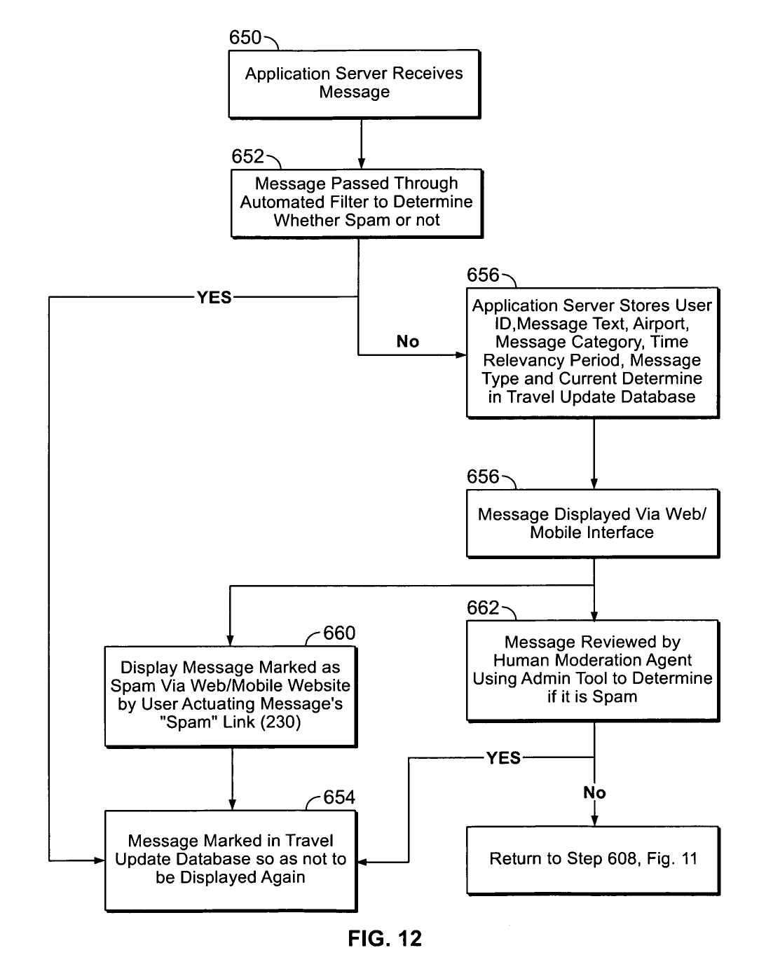

Referring to FIG. 10, an alternative example of a message input webpage 500 of the website is shown. In this example, message input webpage 500 enables a traveler to input text-based travel-related messages associated with a selected airport. The message input webpage 500, seen in FIG. 10, allows for the input of both travel update messages and travel tip messages. Actuation of traveler updates/tips tab 510 at tab bar 520, in this example, provides for the display of the message input webpage 500, FIG. 10, for input of both travel update messages and travel tip messages. The traveler creating and inputting a new travel-related message selects a travel category associated with the travel-related message. Post new update/tip section 512 of message input webpage 500, FIG. 10, in this example, includes message text box 514 for the user to input a new text-based travel-related message. The messages may selectively be time-sensitive travel updates or non-time-sensitive travel tip messages. Prompts 516, 518 are provided allowing a traveler to indicate whether the travel-related message is good news or bad news. Category drop down menu 525 lists various categories that the user selects for association with the travel-related message. Time relevance drop down menu 530 is also provided and allows the traveler to identify the time-frame relevance related to the inputted travel-related message. For instance, the traveler submitting a new message may select from time relevance categories such as: today, a few days, a few weeks, a few months, over a few months. Once the travel-related message text is inserted, and travel category and relevance selections are identified, message posting button 532 may be actuated in order to submit (to the travel update system 22) the inputted travel-related message associated with the selected airport. The travel-related message received at travel update system 22 may be stored at travel update database 32 by the travel category selected from drop down menu 525 and the time relevance category selected from drop down menu 530. If the submitted travel-related message (either as a travel update or travel tip) clears the spam filtering process, as provided in FIG. 12, the message may be displayed on the website.

The examples shown and described in FIG. 2-10 may be employed for communication with personal computing devices 24 interacting with website webserver 42 of travel update system. Receipt and posting of travel-related messages may also be performed through interaction of mobile communication devices 26 with mobile website webserver 44. As understood by those skilled in the art, the corresponding webpages of the mobile website are formatted for display at the mobile communication devices 26.

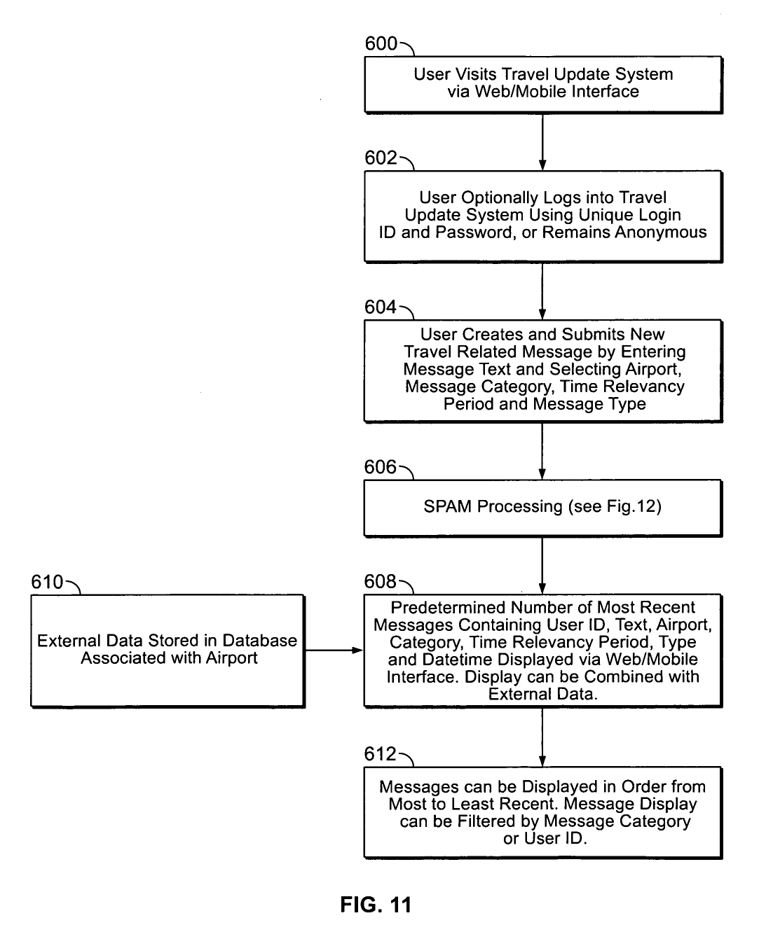

Referring to FIG. 11, a process flow diagram illustrating an example of the travel-related message processing process is provided. In step 600, a user operating a communication device 24, 26 interacts with travel update system 22 through a system interface (e.g. 42, 44, 52, 58). In step 602, the user optionally logs into travel update system 22 using a login ID and password, or remains anonymous. In step 604, the user creates and submits a new travel related message by entering message text and selecting an associated airport and message category. Additionally, time relevancy period and message type information may also be selected and inputted by the user, for example, based on interaction with a particular message input webpage 400, 450, 500. In step 606, the travel-related message received at travel update system 22 undergoes spam processing, as seen in FIG. 12. In step 608, application server 30 of travel update system 22 may display a predetermined number of the most recent messages received within a predetermined time period via website webserver 42 or mobile website webserver 44 interfaces. The travel-related messages may contain user ID, text, airport, category, time relevancy period, message type, and date and time information. In step 610, external data is stored in travel update database 32 that is associated with the airport relating to travel-update messages. Depending on the webpage selected, the display of travel-related messages may be combined with external data to be displayed. Based on user interaction with the travel update system 22, the travel-related messages may be displayed in order from most to least recent, in step 612. Additionally, application server 30 may filter the display of travel-related messages by message category or user ID as seen in step 612.

Referring to FIG. 12, a process flow diagram illustrating the spam processing operation of travel update system 22 is provided. In step 650, application server 30 receives a travel-related message. In step 652, the message is passed through an automated spam filter at the application server 30 to determine if the message is a spam message. If it is determined that the message received is a spam message, then the processing proceeds to step 654 in which the message is marked in the travel update database 32 indicating that the particular message received is not to be displayed. If the message was not determined as being a spam message from the automated filter in step 652, then the processing proceeds to step 656 in which the application server 30 stores various information relating to the message received in the travel update database 32. For instance, for travel-related messages received, the application server 30 may store user ID, message text, airport, message category, time relevance period, message type and current date and time information in the travel update database 32.

In step 658, FIG. 12, the travel-related message received and stored is displayed for website viewing via website webserver interface 42 or mobile website webserver interface 44. In step 660, the message displayed is marked as spam via the website associated with website webserver 42 (or mobile website for mobile website webserver 44) as a result of a user at a communication device 24, 26 actuating a spam link 230 corresponding to the message. Processing then continues to step 654, in which the message is marked in the travel update database 32 indicating that the particular message received is not to be displayed again. In step 662, the message displayed is reviewed by a human moderation agent using an administration tool (such as administration computing device 24A) to determine if the message is a spam message. If the message received is determined not to be a spam message, then the processing returns to step 608, as seen in FIG. 11. If the message received by a moderation agent is determined to be a spam message, then the processing proceeds to step 654 and the message is marked in the travel update database 32 indicating that the particular message received is not to be displayed again.

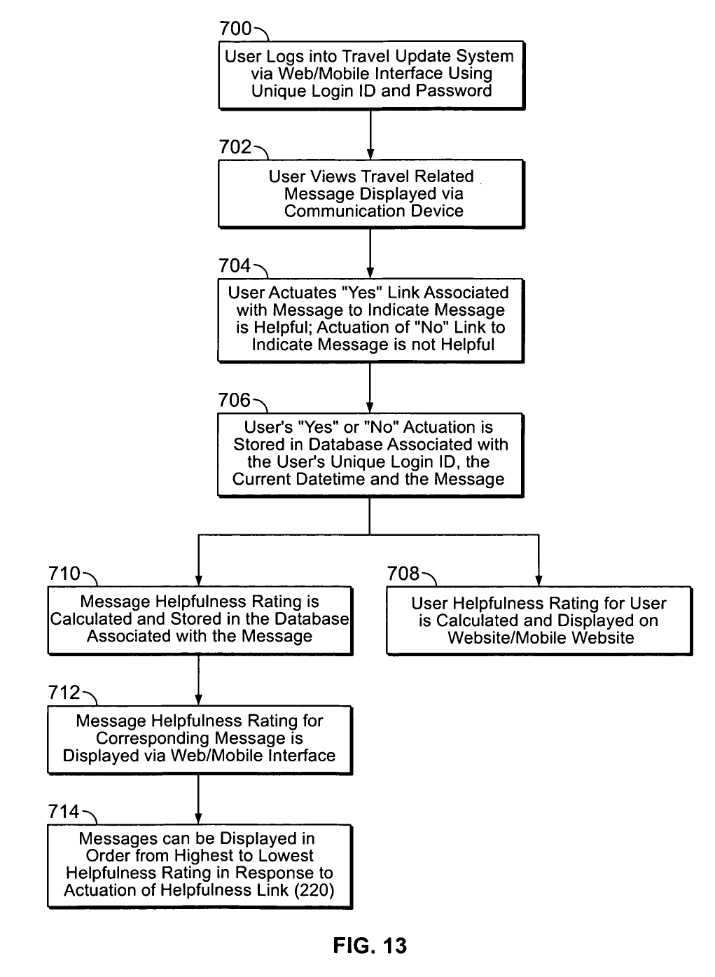

Referring to FIG. 13, a process flow diagram illustrating the process for determining helpfulness ratings is provided. In step 700, a user logs into travel update system 22 by entering a login ID and password at an associated website (or mobile website) through a communication device 24, 26. In step 702, the user views a travel-related message displayed at the communication device 24, 26. In step 704, the user actuates the “yes” voting link 214 associated with the travel-related message to indicate the message is helpful. Actuation of the “no” voting link 216 indicates the travel-related message is not helpful. The “yes” or “no” actuation of the user is stored in memory of the travel update database 32 associated with the user's unique login ID, the current date time and the travel-related message, in step 706. In step 708, a helpfulness rating for the user is calculated and displayed on the website and mobile website. In step 710, the helpfulness rating for the travel-related message is calculated and updated at the application server 30 and stored in memory of the travel update database 32 associated with the message. In step 712, the helpfulness rating for the corresponding travel-related message is displayed for website viewing via website webserver 42 and mobile website webserver 44 interfaces. In step 714, travel update system 22 displays travel-related messages in order from highest to lowest helpfulness rating in response to actuation of helpfulness link 220.

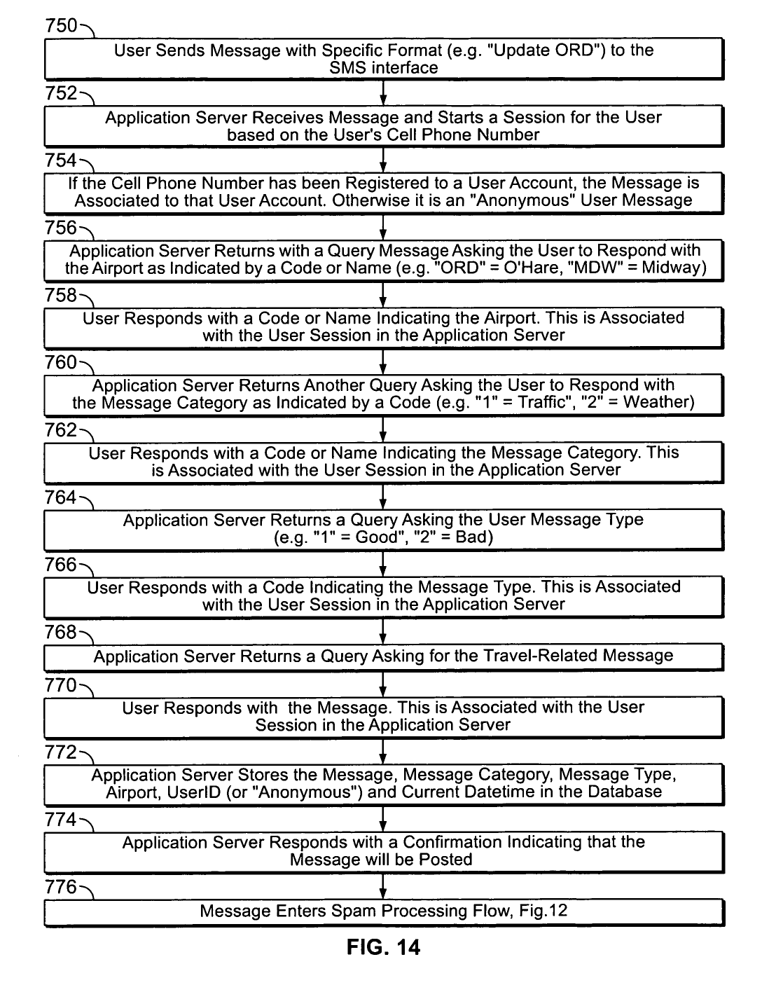

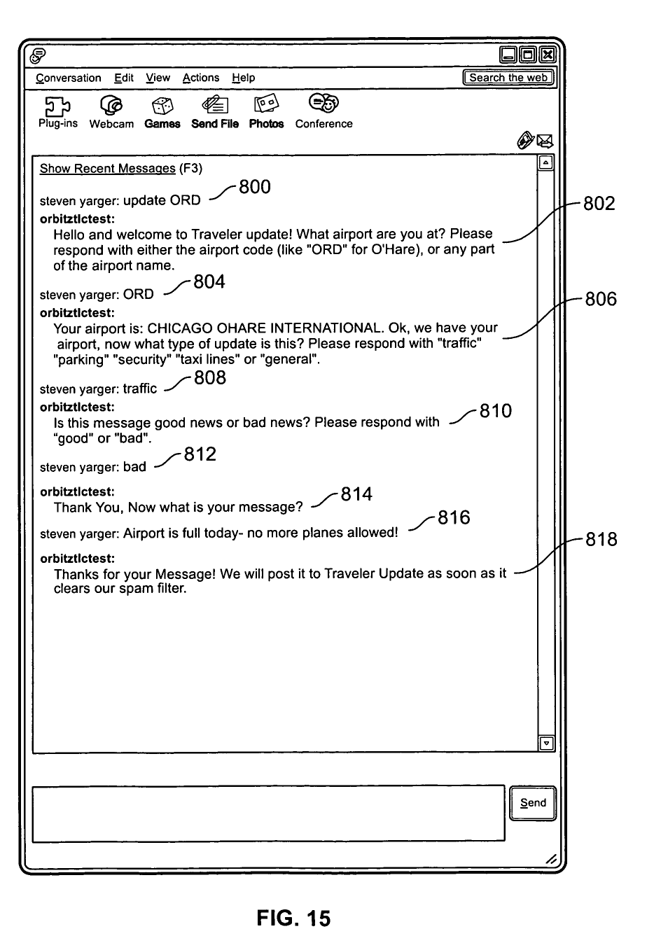

Referring to FIG. 14, a process flow diagram illustrating an SMS interface exchange with an SMS-based communication device for input of a travel-related message is provided. In step 750, a user sends a message with a specific format (such as “update ORD” (O'Hare airport)) from an SMS-enabled communication device to SMS interface 52 as seen at text display 800 in the example in FIG. 15. In step 752, application server 30 receives the message and starts a communication session with the user based on the cell phone number associated with the user's mobile communication device. If the cell phone number has been registered to a user account, then in step 754, the message is associated with that user account. Otherwise, the message from the SMS device is considered as anonymous user message. In step 756, application server 30 returns with a query or prompt (as seen, for example, at 802, FIG. 15) asking the user to respond with the airport as indicated by a code or name (e.g. “ORD”=O'Hare; “MDW”=Midway). In step 758, the user responds with a code or name identifying the relevant airport (as seen, for example, at 804, FIG. 15). The airport identified by code or name is associated with the user communication session in application server 30.

In step 760, FIG. 14, application server 30 returns with another query (as seen, for example, at 806, FIG. 15) asking the user to respond with the message category as indicated by a code or name (e.g. “1”=traffic, “2”=weather, “3”=security, etc.). In step 762, the user responds with a code or name indicating the message category (as seen, for example, at 808, FIG. 15). The response received, indicating a message category, is associated with the user session in application server 30. Application server 30 returns a query or prompt (as seen, for example, at 810, FIG. 15) asking the user to indicate a message type (e.g. “1”=good, “2”=bad) at step 764, FIG. 14. In step 766, the user responds with a code indicating the message type (as seen, for example, at 812, FIG. 15). Application server 30 associates the message type with the user session. In step 768, application server 30 returns with a query or prompt requesting input of the travel-related message (as seen, for example, at 814, FIG. 15). In step 770, the user responds with a travel-related message (as seen, for example, at 816, FIG. 15). Application server 30 associates the travel-related message with the user session. Application server 30 stores the travel-related message, message category, message type, airport, user ID (or “anonymous”), and current date and time in the travel update database 32, in step 772, FIG. 14. Application server 30 responds, in step 774, with a confirmation indicating that the travel-related message will be posted (as seen, for example, at 818, FIG. 15). In step 776, FIG. 14, the travel-related message is subjected to spam processing as described with reference to FIG. 12.

The foregoing description of the preferred embodiments of the invention have been presented for purposes of illustration and description, and are not intended to be exhaustive or to limit the invention the precise forms disclosed. The descriptions were selected to best explain the principles of the invention and their practical application to enable others skilled in the art to best utilize the invention in various embodiments and various modifications as are suited to the particular use contemplated. It is intended that the scope of the invention not be limited by the specification, but be defined by the claims set forth below.

What is claimed is:

1. A computer-implemented method of providing travel-related information to communication devices through a communication network comprising:
receiving travel-related messages from travelers operating communication devices;
storing the received travel-related messages for display by various selected travel-related categories; and
posting the travel-related messages such that the travel-related messages are accessible by travelers operating the communication devices.

2. The computer-implemented method of claim 1 further comprising providing a website adapted to display the travel-related messages received from the communication devices.

3. The computer-implemented method of claim 2 further comprises enabling the received travel-related messages to be displayed in near real time for access by the communication devices communicating with the website.

4. The computer-implemented method of claim 2 further comprising segregating the travel-related messages by airport.

5. The computer-implemented method of claim 4 wherein the step of storing comprises storing the travel-related messages for display by time-sensitive and non-time-sensitive categories; and wherein the time-sensitive travel-related messages are categorized by at least one of airport traffic, airport security line, and flight status categories, and the non-time-sensitive messages are categorized by airport travel tips.

6. The computer-implemented method of claim 2 further comprising receiving travel-related data from external data sources;
aggregating the travel-related messages received from travelers operating the communication devices with travel-related data received from the external data sources; and
storing the travel-related messages and the travel-related data in a database.

7. The computer-implemented method of claim 2 further comprising receiving and responding to travel-related messages in the form of text messages from short message services (SMS)-enabled mobile communication devices.

8. The computer-implemented method of claim 2 wherein said communication devices include instant messaging (IM)-enabled communication devices, and further comprising establishing IM communication with said IM-enabled communication devices.

9. The computer-implemented method of claim 2 further comprising providing a messages webpage on the website, the messages webpage displaying, and identifying by category, the travel-related messages that were received within a predetermined time period from the travelers operating the communication devices.

10. The computer-implemented method of claim 9 further comprising filtering the travel-related messages to be displayed by travel-related category on the messages web page in response to traveler selection of a particular travel-related category.

11. The computer implemented method of claim 9 further comprising providing a traffic webpage on the website, the traffic webpage displaying the travel-related messages received from said communication devices identified as relating to traffic information; and
providing an airport security line webpage on the website, the airport security line webpage displaying the travel-related messages received from the communication devices identified as relating to airport security information.

12. The computer-implemented method of claim 11 further comprising displaying, on the airport security line webpage, airport security statistical information received from an external data source.

13. The computer-implemented method of claim 9 further comprising providing a message input webpage on the website, the message input webpage enabling a traveler to input a text-based travel-related message associated with a particular airport, select a travel category for association with the travel-related message, and submit the travel-related message associated with the airport for access by the communication devices.

14. The computer-implemented method of claim 2 further comprising calculating a percentage of votes received for individual ones of the travel-related messages that indicate the travel-related message was helpful, and displaying the travel-related messages in order from highest percentage to lowest percentage of helpfulness votes; and
storing statistics on individual travelers based on message ratings associated with the travel-related messages submitted by the individual travelers.

15. The computer-implemented method of claim 2 further comprising filtering out spam messages from the travel-related messages received.

16. A computer-implemented system that provides travel-related information to communication devices through a communication network comprising:
an application server in communication with the communication devices, the application server adapted to receive the travel-related messages from the communication devices for display by various travel-related categories;
a database associated with the application server for storing the received travel-related messages for display by various selected travel-related categories; and
wherein the application server is adapted to post the travel-related messages such that the travel-related messages are accessible by travelers operating the communication devices.

17. The computer-implemented system of claim 16 wherein the application server communicates with the communication devices through a webserver, the webserver is configured to provide web pages of a website for displaying the travel-related messages.

18. The computer-implemented system of claim 17 wherein the travel-related messages received at the application server are displayed in near real time for access by the communication devices communicating with the website.

19. The computer-implemented system of claim 17 wherein the database stores the travel-related messages by airport.

20. The computer-implemented system of claim 19 wherein the application server is configured to display the travel-related messages into time-sensitive and non-time-sensitive categories and to display the time-sensitive travel-related messages by at least airport traffic, airport security line, and flight status categories, and the non-time-sensitive messages by airport travel tips.

21. The computer-implemented system of claim 17 further comprising an external data source in communication with the application server; wherein the application server is configured to aggregate the travel-related messages received from the communication devices with travel-related data received from external data sources.

22. The computer-implemented system of claim 17 further comprising a short message services (SMS) interface coupled for communication with the application server, the SMS interface adapted to receive and send travel-related messages in the form of text messages from SMS-enabled mobile communication devices.

23. The computer-implemented system of claim 17 wherein said communication devices include instant messaging (IM)-enabled communication devices, and further comprising an IM interface coupled for communication with the application server, the IM interface adapted to establish IM communication with the IM-enabled communication devices.

24. The computer-implemented system of claim 17 further comprising a messages webpage on the website, the messages webpage displaying, and identifying by category, the travel-related messages that were received within a predetermined time period from the communication devices.

25. The computer-implemented system of claim 24 wherein the application server is adapted to filter the travel-related messages to be displayed by travel-related category on the messages webpage in response to traveler selection of a particular travel-related category.

26. The computer-implemented system of claim 24 further comprising a traffic webpage of said website, the traffic webpage displaying the travel-related messages received from the communication devices identified as relating to traffic information; and
an airport security line webpage of said website, the airport security line webpage displaying the travel-related messages received from the communication devices identified as relating to airport security information.

27. The computer-implemented system of claim 24 further comprising a message input webpage of said website, the message input webpage being configured to receive text-based travel-related messages associated with a particular airport, receive selections of a travel category for association with the travel-related message, and to submit the travel-related message and category selection to the application server.

28. The computer-implemented system of claim 16 wherein the application server is adapted to calculate a percentage of votes received for individual ones of the travel-related messages that indicate the travel-related message was helpful, and displaying the travel-related messages in order from highest percentage to lowest percentage of helpfulness votes; and
wherein the database stores statistics on individual travelers based on message ratings associated with the travel-related messages submitted by the individual travelers.
